(19) United States
(12) Patent Application Publication
(10) Pub. No.: US 2026/0028723 A1
(43) Pub. Date: Jan. 29, 2026

(54) TREATMENT OF FLUIDS

(71) Applicant: KP2M LIMITED, Swansea (GB)

(72) Inventor: Elizabeth MORGAN, Swansea (GB)

(21) Appl. No.: 18/993,406

(22) PCT Filed: Jul. 11, 2023
(86) PCT No.: PCT/GB2023/051819

§ 371 Date: Jan. 10, 2025

(30) Foreign Application Priority Data
Jul. 11, 2022 (GB) 2210146.3

(51) Int. Cl. C25B 1/30; C02F 1/46; C25B 11/04; C25B 15/02

(52) U.S. Cl. CPC C25B 1/30; C02F 1/46; C25B 11/04; C25B 15/02

(57) ABSTRACT

A fluid treatment apparatus (1) for generating hydrogen peroxide, the apparatus (1) comprises a tank (2) for the flow therethrough of fluid, the tank (2) having an inlet (3) for the receipt of fluid and an outlet (4) for the egress of fluid, located within the tank (2) is a first plate (7A) comprising a metal oxide surface, a second plate (7B) comprises a metal oxide surface and a third plate (8) located between the first and second plates (7A, 7B), wherein the tank (2) and the third plate (8) provide cathodes and the first and second plates (7A, 7B) provide anodes.

The invention relates to the treatment of fluids. More particularly, the invention relates to the prophylaxis, treatment or decontamination of fluids using oxidising agents.

Treatment or decontamination of fluids is frequently required to remove entrained matter (e.g. suspended or dissolved matter) and/or to disinfect impurities. The fluid to be treated or decontaminated may especially be contaminated water, for example, drinking water, waste water, industrial effluents, shipboard waters, process waters, ground run-off waters or leachate water. The fluids may contain one or more contaminants, for example, inorganics, organics, suspended material, colloidal matter, metals, organo-metalloids, radionuclides, herbicides, pesticides and bacteria, viruses and other microorganisms. Alternatively, fluids which become contaminated may be process fluids.

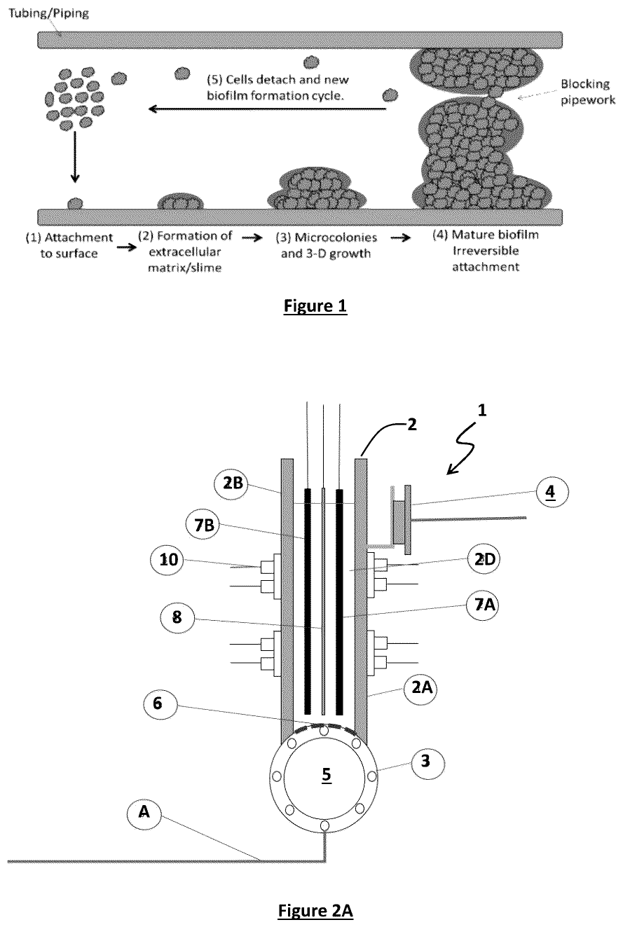

It is known that biofilms can build up in pipework for and containers of fluids. Biofilms are bacterial communities that are able to develop into thick and robust layers of mucilage which adhere to many surfaces. Once cells have adhered to a surface they form an extracellular matrix which protects the cells and allows them to grow. As the biofilm develops it will become permanently attached to the surface and will provide a site from which cells detach and carried through the fluid medium to attach to new sites. FIG. 1 provides a schematic of biofilm development.

It is known to treat biofilm build up chemically, for example by the use of biocidal oxidising agents or enzymes (e.g. Lui et al., MethodsX (2014) 1; 130-136). It has also been found that high pressure cleaning can be effective in removing biofilm deposits. However, high pressure cleaning runs the risk of spreading the biofilm via, for example, aerosol formation and the use of chemical agents is problematic because it requires transportation and appropriate dosing equipment to provide an efficacious dose of chemical agent.

As such, it would be beneficial to have a method of treating biofilms and/or otherwise to provide disinfection which limits the risk of further decontamination but which does not rely on dosing a system to be treated with chemicals, thereby reducing transportation costs and the associated capital and operational expense necessary to dose chemicals into a system. It would also be beneficial to provide a means of preventing biofilm build up in pipe work or other conduits and fluid storage tanks which are susceptible to the build-up of biofilms. It would also be beneficial to have means for generating oxidising agents, for example generating oxidising agents in line, to treat water or other fluids.

The current invention seeks to at least partially mitigate one or more of these issues.

Accordingly, a first aspect of the invention provides a fluid treatment apparatus for generating hydrogen peroxide, the apparatus comprises a tank for the flow therethrough of fluid, the tank having an inlet for the receipt of fluid and an outlet for the egress of fluid, located within the tank is a first plate comprising a metal oxide surface, a second plate comprising a metal oxide surface and a third plate located between the first and second plates, wherein the tank and the third plate provide cathodes and the first and second plates provide anodes.

It has been found that the electrochemical treatment of fluid can lead to the generation of significant amounts of hydrogen peroxide which is effective in the treatment of biofilms and/or prevention of biofilms and/or the reduction in biofilm growth.

Preferably, the first, second and/or third plate are flat. The first second and/or third plate may be solid plates.

Preferably the first and second plates are formed of a conductive substrate or body to which the metal oxide surface is applied. The conductive substrate or body and the metal oxide surface are preferably not formed from identical materials. In an embodiment the conductive substrate or body is formed from titanium and the metal oxide surface comprises one or more non-titanium oxides, preferably plural non-titanium oxides.

In an embodiment, the metal oxide surface is formed from a mixed metal oxide (MMO). In an embodiment, the MMO comprises metal oxides selected from the platinum group metals (rhodium, iridium, palladium, platinum, ruthenium and osmium), tin oxide, gold oxide, silver oxide and combinations of the same. In an embodiment, the MMO is combined with tantalum, antinomy and/or titanium oxides. Whilst we have found that many MMOs work we prefer not to use platinum MMOs (i.e. MMOs comprising platinum oxides). Also, we have found that MMOs of both iridium oxide and tin oxide are capable of generating significant amounts of in situ hydrogen peroxide, we have surprisingly found that the use of iridium oxide leads to higher concentrations of hydrogen peroxide at comparable applied powers.

In an embodiment, the metal oxide surface of the first plate and/or second plate is an iridium/tantalum (IrO₂/Ta₂O₅) MMO. In an embodiment the first and/or second plate is a tin/antinomy (SnO₂/Sb₂O₅) MMO.

In an embodiment, the first plate and/or the second plate is from 1 to 10 mm thick, for example from any one of 1, 2, 3, 4 mm thick to any one of 9, 8, 7, 6, 5, 4 mm thick.

In an embodiment, the metal oxide surface is less than 50 μm thick, for example from 1 to 50 μm thick, say from any of 1, 2 or 3 μm thick to any one of 45, 40, 35, 30, 35, 30, 15, 10 μm thick. In an embodiment the metal oxide surface is from 2 to 10 μm thick, say from 3 to 10 μm thick.

Conveniently, the metal oxide surface may be plasma coated, electrocoated or spray coated or coated by electrochemical deposition, biomimetic coating, sol-gel coating.

Preferably, the tank and the third electrode are formed from stainless steel. We prefer to use SS-316 as it has proven to be the most robust in use.

In an embodiment, the third electrode may be from 1 to 10 mm thick, for example from any one of 1, 2, 3, 4 to any one of 9, 8, 7, 6, 5, 4 mm thick. Optionally, the third electrode is the same thickness as the first and/or second electrode.

The terms the first electrode, second electrode and third electrode are used interchangeably with the first plate, second plate and third plate, respectively. That is, the first, second and third plates are first, second and third electrodes.

Preferably, the third plate is not a mesh. Advantageously, this allows for lateral flow of the fluid through the fluid treatment apparatus.

In an embodiment, the walls of the tank may be from 1 to 20 mm thick, for example from 2-10 mm thick. Preferably, the walls of the tank are the same thickness as the first and/or second plate electrode. Optionally, the walls of the tank are thicker than the third electrode.

Advantageously, the presence of the third electrode separates the treatment zone of the apparatus into parallel electrochemical cells in which a first cell comprises a first tank wall, the first plate electrode and the third electrode and a second cell comprises a second tank wall, the second plate electrode and the third electrode. This architecture then provides eight active surfaces upon which hydrogen peroxide can be formed.

A further aspect of the invention provides a fluid treatment apparatus for generating hydrogen peroxide, the apparatus comprises a tank for the flow therethrough of fluid, the tank having an inlet for the receipt of fluid and an outlet for the egress of fluid, located within the tank is a first plate comprising a metal oxide surface, a second plate comprising a metal oxide surface and a third plate located between the first and second plates, wherein the tank and the third plates provide cathodes and the first and second plates provide anodes, wherein the metal oxide surface of the first and/or second plate is an iridium/tantalum (IrO₂/Ta2O₅) mixed metal oxide and wherein the iridium/tantalum (IrO₂/Ta₂O₅) mixed metal oxide surface is from 2 to 10 μm thick.

A yet further aspect of the invention provides a fluid treatment apparatus for generating hydrogen peroxide, the apparatus comprises a tank for the flow therethrough of fluid, the tank having an inlet for the receipt of fluid and an outlet for the egress of fluid, located within the tank is a first plate comprising a metal oxide surface, a second plate comprising a metal oxide surface and a third plate located between the first and second plates, wherein the tank and the third plates provide cathodes and the first and second plates provide anodes, wherein the metal oxide surface of the first and/or second plate is an tin/antinomy (SnO₂/Sb₂O₅) MMO surface and wherein the tin/antinomy (SnO₂/Sb₂O₅) MMO surface is from 2 to 10 μm thick.

In an embodiment, the metal oxide surface of the first plate is an iridium/tantalum (IrO₂/Ta₂O₅) MMO or a tin/antinomy (SnO₂/Sb₂O₅) MMO and the metal oxide surface of the second plate is a tin/antinomy (SnO₂/Sb₂O₅) MMO surface or an iridium/tantalum (IrO₂/Ta₂O₅) MMO. The metal oxide surface of each of the first and second plates may be from 2 to 10 μm thick.

Advantageously, the different materials can be used at different applied powers. For example, if a low concentration of peroxide is required it may be possible to use the tin MMO requiring lower power, whereas if a higher concentration of hydrogen peroxide is required the iridium MMO coating will be favoured.

A further aspect of the invention provides a fluid treatment apparatus, the apparatus comprises a tank for the flow therethrough of fluid, the tank having an inlet for the receipt of fluid and an outlet for the egress of fluid, located within the tank is at least a first plate comprising a metal oxide surface, wherein the tank provides a cathode and the first plate provides an anode and wherein the metal oxide surface comprises one or both of iridium oxide and tin oxide, preferably iridium oxide.

Preferably, the metal oxide surface comprises a mixed metal oxide surface.

In an embodiment, the metal oxide surface is less than 50 μm thick, for example from 1 to 50 μm thick, say from any of 1, 2 or 3 μm thick to any one of 45, 40, 35, 30, 35, 30, 15, 10 μm thick. In an embodiment the metal oxide surface is from 2 to 10 μm thick, say from 3 to 10 μm thick.

Conveniently, the metal oxide surface may be plasma coated, electrocoated or spray coated.

Preferably, the tank is formed from stainless steel. We prefer to use SS316 as it has proven to be the most robust in use.

In an embodiment, the fluid treatment apparatus further comprises a second plate anode.

Optionally, the fluid treatment apparatus further comprises a plate cathode. The plate cathode may be located between the first and second plate anodes.

In an embodiment, the plate cathode is from 1 to 10 mm thick, for example from 1 to 9, 8, 7, 6, 5, 4 mm thick. Optionally, the plate cathode is the same thickness as the first and/or second plate anode.

In an embodiment, the walls of the tank are from 1 to 20 mm thick, for example from 2-10 mm thick. Preferably the walls of the tank are the same thickness as the first and/or second plate anode electrode. Optionally, the walls of the tank are thicker than the plate cathode.

The tank and, where present, the plate cathode are preferably grounded.

Optionally, the apparatus comprises ultrasonic transducers.

Optionally, ultrasonic transducers are mounted to the exterior surface of the tank.

Advantageously, we have found that the ultrasound generated by the ultrasonic transducers may disrupt a surface layer of fluid in proximity to the metal oxide surface, thereby creating local turbulence which beneficially mixes the surface layer to encourage greater flow of hydrogen peroxide within the fluid. As such the ultrasonic transducers are provided to limit or destabilise laminar flow across the metal oxide surfaces.

A further aspect of the invention provides a method of treating or preventing the build-up of biofilm and/or providing disinfection, using an electrochemical cell, the cell comprising a tank having an inlet and an outlet and an anode located within the tank, the anode comprising a metal oxide surface, wherein the metal oxide surface comprises one or both of iridium oxide or tin oxide, the method comprising connecting the tank and the anode to an electrical power supply and passing fluid from the inlet to the outlet and into proximity with the anode to generate hydrogen peroxide within the fluid.

The method may further comprise passing the fluid from the outlet to a site of use.

Advantageously, the electrochemical cell can be located in a process line and can be used to continually or intermittently generate hydrogen peroxide for the downstream treatment of biofilm build-up and/or for the prevention of biofilm build-up and/or provide disinfection by the electrochemical generation of oxidising agents.

We have found that the anodes do not substantially deplete due to electrochemical effects over time and so once installed in a flow line the apparatus can be deployed to effectively reduce and/or prevent biofilm build up and/or provide disinfection.

The invention will now be described by way of example only and with reference to the accompanying drawings, in which:

FIG. 1 is a schematic of biofilm development;

FIG. 2A and FIG. 2B are respectively a section view and a side elevation of apparatus according to the invention;

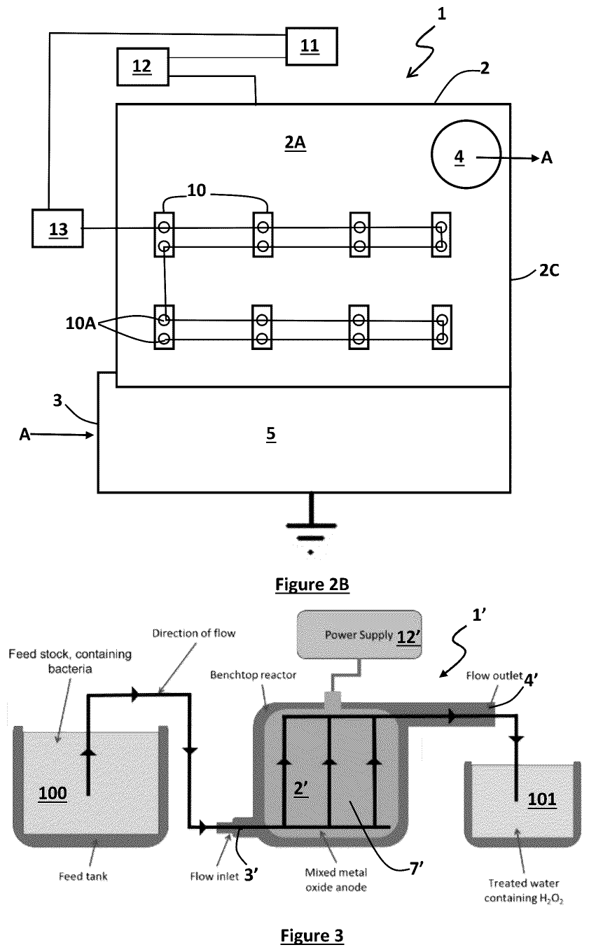

FIG. 3 is schematic representation of a test rig used in the Examples;

FIG. 4 is a graph showing the results of Example 1;

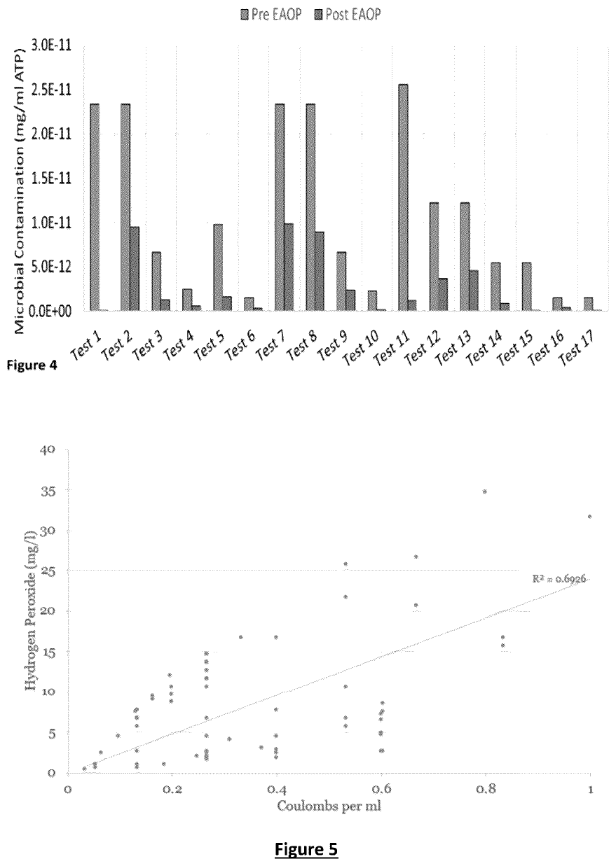

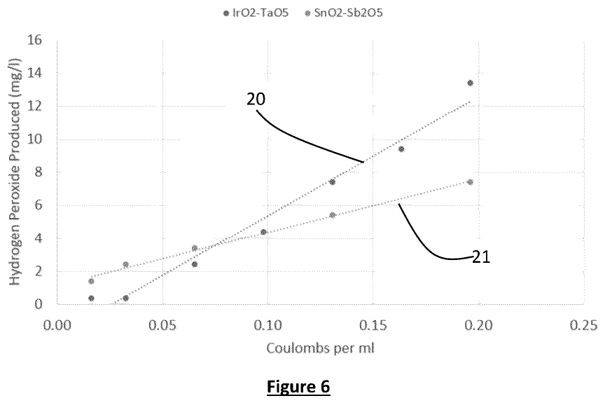

FIG. 5 is a graph of the results of Example 2; and

FIG. 6 is a graph of the results of Example 3.

Referring firstly to FIG. 1, as can be seen a typical biofilm production cycle starts with cells attaching to a surface of, for example, a pipe [Step (1)]. As the cells grow and develop an extracellular slime develops which protects the and allows the cells to grow [Step (2)]. The cells develop into microcolonies and grow away from the surface to which they are attached [Step (3)]. A mature biofilm may totally occlude a pipe in which the biofilm has developed [Step (4)]. Whether or not the biofilm totally occludes the pipe, the presence of the biofilm is deleterious for plural reasons. Firstly, it can affect the flow through the pipe, secondly it provides a source of cells which can be carried with the process fluids and thirdly it can provide a source of cells for further biofilm growth at different sites.

Referring now to FIGS. 2A and 2B, there is shown an apparatus 1 for use in the generation of hydrogen peroxide for the prophylaxis or treatment of biofilm and/or for the disinfection of a fluid.

The apparatus 1 comprises a tank 2 in the form of a rectangular body having front and back walls 2A, 2B and end walls 2C to define a treatment volume 2D. The apparatus 1 is provided with an inlet 3 and an outlet 4 for fluid. The inlet 3 is in communication with a manifold 5 having a perforate portion 6 to allow fluid to pass from the manifold 5 and into the treatment volume 20. As will be appreciated, and indicated by the arrow A, fluid will pass from the inlet 3 to the outlet 4 via the manifold 5 through the perforate portion 6 and upwardly towards, and thence out from, the outlet 5.

The walls 2A, 2B, 2C are typically formed from stainless steel and may be 3 mm thick. The manifold 5 is also typically formed from stainless steel.

Located within the treatment volume 2D is a first plate electrode 7A, a second plate electrode 7B and an intervening plate electrode 8.

The first plate electrode 7A and the second plate electrode 7B are made from titanium plates to which a surface coating of a mixed metal oxide has been applied. The titanium plates are typically 3 mm thick, for example 5 mm thick and the mixed metal oxide surface layer is typically less than 20 μm thick, say less than 10 μm thick. The intervening plate 8 is typically formed from stainless steel and may be 3 mm thick.

Mounted on the exterior of the walls 2A, 2B are plural ultrasound generators 10, each comprising at least one, but preferably comprising plural, ultrasonic transducers 10A.

The apparatus 1 is provided with an electrode power supply 11, an ultrasound generator power supply 12 and a master controller 13. The master controller 13 is configured to control operation of the apparatus 1 and is operably connected to the electrode power supply 11 and the ultrasound power supply 12. Advantageously, the master controller 13 may also regulate fluid flow through the apparatus by controlling one or more downstream or upstream valves (not shown).

The tank 2 and the intervening plate 8 provide cathodes and the first plate electrode 7A and the second plate electrode 7B provide anodes. The tank 2 and the intervening plate 8 are connected to earth. The tank being earthed allows the ultrasonic generators 10 to be connected to the surface of the tank 2.

In use, the apparatus 1 is connected via electric circuitry to the electrode power supply 11 and the ultrasound power supply 12 under the control of the master controller 13. Fluid to be treated (e.g. water) is caused or allowed (for example under the control of the mater controller 13) to flow through the apparatus 1 and is subjected to electrochemical treatment at the cathodes and anodes. Indeed, it is possible to generate hydrogen peroxide from water at each of the electrode surfaces (i.e. the cathode and anode surfaces), as follows:

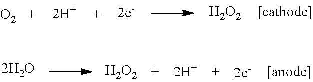

With a tank 2 having a volume of 560 mm×1040 mm and a width of 100 mm it is possible to process 38 m³/hr. Larger tanks are able to process 100 m³/hr of fluids.

In order that the invention may be more fully understood a set of Examples have been conducted:

### EXAMPLE 1

A test rig was prepared as shown in FIG. 3 having a feedstock tank 100 connected to a benchtop apparatus 1′, made in accordance with the above description but of smaller size, comprising a tank 2′ and a power supply 12′, and a treated water container 101 to receive the output from the reactor 1′.

The tank 2′ has a volume of 4 litres and dimensions of ca. 320×250×50 mm.

A single titanium plate anode 7′ (180×200×3 mm) having a 6 μm thick MMO coating (IrO₂/Ta₂O₅) was located in the tank 2′, which was earthed. A power supply 12′ was used to energise the apparatus and to form an electrochemical cell.

The voltage applied was up to 42 V, at a current of up to 10 A. 4 30-40 kHz ultrasonic transducers were attached to the exterior surface of the tank 2′ and operated at a power of 58 W.

Fluid flowed through the apparatus 1′ at a flow rate of 0.003 m³/hr.

In order to determine the efficiency for eliminating bacteria the fluid in the feed tank was dosed with bacteria and bacterial load treated water container 101 was compared to that in the feedstock tank 100.

As a proxy for determining bacterial load, ATP was measured using the AquaSnap Free® system from Hygiena LLC.

The results for 17 tests are shown in FIG. 4. In each test an aliquot of the fluid was extracted for testing before and after passage of the bulk fluid through the apparatus 1′.

As shown, the different tests used different starting microbial loads. In each case, the power applied was identical, meaning that the generated peroxide concentration was the same in each case.

The tests show an up to 95% reduction in bacterial load.

### EXAMPLE 2

In order to assess the capacity of the system to generate hydrogen peroxide, the apparatus 1′ of Example 1 was used and the electrochemical power was varied to find the relationship between power applied and hydrogen peroxide generated.

Hydrogen peroxide concentration was determined by titration with potassium permanganate.

The results are shown in FIG. 5.

As can be seen, according to a line of best fit, power is directly proportional to the amount of hydrogen peroxide generated, clearly demonstrating that the system can be tuned for particular needs.

For example, the apparatus 1, 1′ can be operated at a certain level for‘normal’ use or expected loading and, for example, the power can be increased to cope with a peak demand in bacterial load. Alternatively, the power may be down-modulated to cope with a decrease in bacterial loading. Further, should there be a predictable change in bacterial loading (for example diurnally) the apparatus can cope by changing the power applied as a consequence.

Because the apparatus 1, 1′ simply requires a source of electricity, rather than the addition of wet chemicals, it is imminently suitable to cope with changes in requirements. For example, by upstream monitoring, and knowledge of flow rates, the master controller 13 can predictably alter the power applied to cope with changes in demand. This not only improves efficiency but also reduces costs as only the requisite amount of power is applied.

### EXAMPLE 3

In order to assess the efficacy of anode materials we tested the following anode plates 7′ in the test rig of Example 1.

| | Anode Plate 1 | Anode Plate 2 |
|---|---|---|
| Dimensions (mm) | 180 × 200 × 3 | 180 × 200 × 3 |
| Material | Ti | |
| Coating | MMO - IrO₂/Ta₂O₅ | MMO - SnO₂/Sb₂O₅ |
| Coating thickness (μm) | 6 | 6 |
| Voltage (V) | 42 | 42 |

In each case the flow rate through the test rig was identical and the current was varied.

The results are shown in FIG. 6. The results for Anode Plate 1 and shown by line 20 and those for Anode Plate 2 are shown by line 21.

Again, hydrogen peroxide concentration was determined by titration with potassium permanganate.

The results again show that the amount of hydrogen peroxide generated is linear with respect to power but there is a marked difference between the behaviour of the two materials with the iridium oxide MMO generating more peroxide at higher powers.

This data demonstrates that different materials may be usable at different applied powers. For example, if a low concentration of peroxide is required it may be possible to use the tin oxide MMO (requiring lower power, whereas if a higher concentration of hydrogen peroxide is required the iridium MMO coating will be favoured.

This opens the possibility of having different anodes for different requirements and/or the possibility of changing anodes, perhaps automatically, if different conditions are experienced to minimise power usage.

As has been demonstrated by the above Examples, the apparatus of the invention is capable of generating usable amounts of hydrogen peroxide for the treatments of fluids. The generation of oxidising agents is useful to prevent the build-up of biofilms and/or may be used to prevent the development of biofilm, as a form of prophylaxis. Further, oxidising agents such as hydrogen peroxide are useful in the disinfection or treatment of fluids in many industries such as aquaculture, food processing and the water industry to prevent damage to equipment, help combat the spread of pathogens and to ensure cleanliness.

1. A fluid treatment apparatus for generating hydrogen peroxide, the apparatus comprises a tank for the flow therethrough of fluid, the tank having an inlet for the receipt of fluid and an outlet for the egress of fluid, located within the tank is a first plate comprising a metal oxide surface, a second plate comprising a metal oxide surface and a third plate located between the first and second plates, wherein the tank and the third plate provide cathodes and the first and second plates provide anodes.

2. The apparatus according to claim 1, wherein the first and second plates are formed of a conductive substrate or body to which the metal oxide surface is applied.

3. The apparatus according to claim 2, wherein the conductive substrate or body and the metal oxide surface are formed from non-identical materials.

4. The apparatus according to claim 2, wherein the conductive substrate or body is formed from titanium and the metal oxide surface comprises non-titanium oxides.

5. The apparatus according to claim 1, wherein the metal oxide surface comprises one or more of oxides of rhodium, iridium, palladium, platinum, ruthenium, osmium, tin, gold, silver, tantalum and antimony.

6. The apparatus according to claim 1, wherein the metal oxide surface comprises a mixed metal oxide (MMO).

7. The apparatus according to claim 1, wherein the first plate and/or the second plate is from 1 to 10 mm thick.

8. The apparatus according to claim 1, wherein the metal oxide surface is less than 50 μm thick.

9. (canceled)

10. (canceled)

11. A fluid treatment apparatus, the apparatus comprises a tank for the flow therethrough of fluid, the tank having an inlet for the receipt of fluid and an outlet for the egress of fluid, located within the tank is at least a first plate comprising a metal oxide surface, wherein the tank provides a cathode and the first plate provides an anode and wherein the metal oxide surface comprises one or both of iridium oxide and tin oxide.

12. The apparatus according to claim 11, wherein the metal oxide surface is a mixed metal oxide surface.

13. The apparatus according to claim 12, further comprising a second plate anode.

14. The apparatus according to claim 13, wherein the second plate anode has a metal oxide surface.

15. The apparatus according to claim 14, further comprising a plate cathode.

16. The apparatus according to claim 15, wherein the plate cathode is located between the first and second plate anodes.

17. (canceled)

18. (canceled)

19. (canceled)

20. (canceled)

21. (canceled)

22. (canceled)

23. (canceled)

24. The apparatus according to claim 1, further comprising a controller configured to control operation of the apparatus.

25. (canceled)

26. The apparatus according to claim 24, wherein the controller is operably connected to one or more sensors.

27. The apparatus according to claim 26, wherein the controller is configured to monitor the bacterial load.

28. (canceled)

29. The apparatus according to claim 1, wherein the metal oxide surface of the first plate and the second plate is an iridium/tantalum (IrO₂/Ta₂O₅) mixed metal oxide or a tin/antinomy (SnO₂/Sb₂O₅) mixed metal oxide.

30. (canceled)

31. A method of treating fluids using an electrochemical cell, the cell comprising a tank having an inlet and an outlet and an anode located within the tank, the anode comprising a metal oxide surface, wherein the metal oxide surface comprises one or both of iridium oxide or tin oxide, the method comprising connecting the tank and the anode to an electrical power supply and passing fluid from the inlet to the outlet and into proximity with the anode to generate hydrogen peroxide within the fluid.

32. (canceled)

33. The apparatus according to claim 24, wherein the controller is configured to do either or both of:
(a) vary the power applied to the apparatus from a power source, and
(b) to cause the first and/or second plate to be automatically changed in dependence on a measured condition.
